(19) United States
(12) Patent Application Publication
(10) Pub. No.: US 2019/0022718 A1
(43) Pub. Date: Jan. 24, 2019

(54) Remedial treatment of metal ions

(71) Applicant: Robert HILL, Richardson, TX (US)

(72) Inventor: Robert HILL, Richardson, TX (US)

(21) Appl. No.: 15/932,413

(22) Filed: Feb. 27, 2018

Related U.S. Application Data
(60) Provisional application No. 62/600,729, filed on Feb. 27, 2017.

(51) Int. Cl. B09C 1/08; B09C 1/02

(52) U.S. Cl. CPC B09C 1/08; C01B 33/32; B09C 1/02

(57) ABSTRACT

A remedial composition comprising a soluble silicate, a surfactant, a polyol and water is disclosed. The remedial composition of the present invention is generally intended for use in the treatment of water, soil, sand, fly ash and other mediums that may contain hazardous materials. In one embodiment of the present invention the soluble silicate of the remedial composition has a mole ratio of about 2.6 to about 3.9 moles silicate per mole of alkali metal oxide. In yet another embodiment of the present invention the remedial composition will be utilized as part of a treatment method for lowering the concentrations of free metal ions in water, soil, sand, fly ash and other mediums.

### CROSS-REFERENCE TO RELATED APPLICATIONS

This application is related to and claims priority to U.S. Provisional Patent Application 62/600,729 entitled “Remedial Treatment Of Metal Ions” filed Feb. 27, 2017. The provisional application is hereby incorporated in its entirety by specific reference thereto.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

The present invention relates to the remedial treatment of metal ions and methods for a variety of applications. More specifically, the present invention relates to a remedial treatment utilizing a composition comprising a soluble silicate, a surfactant, a polyol, and water.

### BACKGROUND OF THE INVENTION

There is a need for pollution remedial compositions and treatment methods that may be utilized in the clean-up of water, soil, sand, fly ash and other media which may contain hazardous materials. Such hazardous materials may include pollutants that contain various metal ions, namely lead, cadmium, chromium and mercury. Even metals that are needed by people and animals as mineral nutrients, including iron, copper, and zinc, may be hazardous if found in too high a concentration. Most of these pollutants cannot be simply buried or dumped without presenting a significant health threat to humans and wildlife. These pollutants may often break down or leach out of the soil, landfills or other mediums in which they have been deposited and into the ground water thus contaminating drinking water and endangering fish and other wildlife many miles away from the actual dumping site.

Common heavy metal pollutants include lead, cadmium, chromium and mercury. Heavy metals are naturally occurring materials, but are often concentrated to highly toxic levels by various industrial activities such as mining, smelting and refining. These metals are also commonly found in products like batteries, circuit boards, and other electronic devices. It is not possible to further degrade basic elements such as these. Heavy metals are particularly hazardous under conditions where these pollutants may be acted upon by water, especially acid rain, and leached from the soil and into a water table. Accordingly, it would be desirable to remediate these materials by chemically binding to them in such a way as to render them essentially non-bioavailable, non-mobile, and far less susceptible to leaching from soil.

Clearly, there is a need for a remedial composition and treatment method for water, soil, sand, fly ash and other mediums that may contain hazardous waste materials. There is an urgent need for a remedial composition for the economical and effective cleanup and containment of a broad spectrum of pollutants containing dangerously high levels of metal ions.

### SUMMARY OF THE INVENTION

The remedial composition of the present invention is generally intended for use in the treatment of water, soil, sand, fly ash and other mediums that may contain hazardous materials. In a number of exemplary embodiments of the present invention a remedial composition comprising a soluble silicate, a surfactant, a polyol and water is disclosed. In one embodiment of the present invention the soluble silicate of the remedial composition has a mole ratio of about 2.6 to about 3.9 moles of silicate per mole of alkali metal oxide. In yet another embodiment of the present invention the remedial composition will be utilized as part of a treatment method for lowering the concentrations of free metal ions in water, soil, sand, fly ash and other mediums.

### BRIEF DESCRIPTION OF THE DRAWINGS

The present invention will be better understood in view of the detailed description in conjunction with the following figures and in which:

FIG. 1 is a summary of resulting TCLP data following the treatment of various metal ions in lab grade sand;

FIG. 2A is a chart showing the reduction of aluminum ion concentrations in several different pH ranges;

FIG. 2B is a chart showing the reduction of arsenic ion concentrations in several different pH ranges;

FIG. 2C is a chart showing the reduction of boron ion concentrations in several different pH ranges;

FIG. 2D is a chart showing the reduction of barium ion concentrations in several different pH ranges;

FIG. 2E is a chart showing the reduction of calcium ion concentrations in several different pH ranges;

FIG. 2F is a chart showing the reduction of cadmium ion concentrations in several different pH ranges;

FIG. 2G is a chart showing the reduction of chromium ion concentrations in several different pH ranges;

FIG. 2H is a chart showing the reduction of copper ion concentrations in several different pH ranges;

FIG. 2I is a chart showing the reduction of iron ion concentrations in several different pH ranges;

FIG. 2J is a chart showing the reduction of magnesium ion concentrations in several different pH ranges;

FIG. 2K is a chart showing the reduction of manganese ion concentrations in several different pH ranges;

FIG. 2L is a chart showing the reduction of molybdenum ion concentrations in several different pH ranges;

FIG. 2M is a chart showing the reduction of lead ion concentrations in several different pH ranges;

FIG. 2N is a chart showing the reduction of selenium ion concentrations in several different pH ranges;

FIG. 2O is a chart showing the reduction of silicon ion concentrations in several different pH ranges;

FIG. 2P is a chart showing the reduction of vanadium ion concentrations in several different pH ranges;

FIG. 2Q is a chart showing the reduction of zinc ion concentrations in several different pH ranges;

FIG. 3 is a summary of target pH ranges for the treatment of various metal ions;

FIG. 4A is a chart showing the results of treatment of arsenic ions in water;

FIG. 4B is a chart showing the results of treatment of barium ions in water;

FIG. 4C is a chart showing the results of treatment of cadmium ions in water;

FIG. 4D is a chart showing the results of treatment of chromium ions in water;

FIG. 4E is a chart showing the results of treatment of copper ions in water;

FIG. 4F is a chart showing the results of treatment of iron ions in water;

FIG. 4G is a chart showing the results of treatment of lead ions in water;

FIG. 4H is a chart showing the results of treatment of manganese ions in water;

FIG. 4I is a chart showing the results of treatment of mercury ions in water;

FIG. 4J is a chart showing the results of treatment of molybdenum ions in water;

FIG. 4K is a chart showing the results of treatment of nickel ions in water;

FIG. 4L is a chart showing the results of treatment of selenium ions in water;

FIG. 4M is a chart showing the results of treatment of vanadium ions in water; and

FIG. 4N is a chart showing the results of treatment of zinc ions in water.

### DETAILED DESCRIPTION

In its most basic form, the remedial composition is a concentrate of a soluble silicate, a surfactant, a polyol and water. These components may be combined by blending about 50 to about 70 wt % soluble silicate, about 0.1 to about 2.5 wt % surfactant, about 0.1 to about 5 wt % polyol, and about 32.5 to about 49.8 wt % water. The concentrated remedial composition may also be further diluted with water in ratios ranging from about 1 part water to about 1 part remedial composition up to and including about 30 parts water to 1 part remedial composition to create a wide variety of useful treatment solutions.

The first component of the remedial composition is a soluble silicate. A soluble silicate is an aqueous solution containing a particular mole ratio of silicate to alkali metal oxide. The most common and most widely used soluble silicates are those of sodium or potassium, but it is believed that magnesium, calcium or lithium silicate may also be used to create a suitable remedial composition. For the composition of the present invention it is usually desirable to use a sodium silicate, as it is both effective and economical.

Most commercially available aqueous silicate solutions have about 35% to about 40% dissolved solids content and have a preferred amount of about 38% dissolved solids content as provided by the manufacturer. Soluble silicates are commercially available in a wide range of mole ratios of silicate to alkali metal oxide, ranging from about 1:1 to about 4:1. For the present invention it is often desirable to select soluble silicates having a ratio of about 2.6 to about 3.9 moles of SiO₂ per mole of Na₂O. In one preferred embodiment, the soluble silicate will have a ratio of about 3.1 to about 3.3 moles of SiO₂ per mole of Na₂O. In alternative embodiments using potassium silicate, the desired and preferred mole ratios would remain about the same as those indicated for sodium silicate. The soluble silicates meeting these criteria are particularly well suited for producing a remedial composition and are available from a number of vendors in the United States including Philadelphia Quartz (PQ Corp).

Many commonly used soluble silicates having mole ratios of about 2:1 or less are quite alkaline in nature and have pH values greater than 12.5. These silicates would produce a remedial composition that, while quite effective at treating hazardous waste, would be caustic to human skin and create additional concerns for the environment. It would be a considerable benefit for the remedial composition to not cause additional concerns to fish and wildlife while being used to clean up hazardous waste. By selecting a soluble silicate having a mole ratio of about 2.6 to about 3.9 moles of SiO₂ per mole of Na₂O, it is possible to produce a remedial composition having a pH value of about 10.0 to about 11.9. Moreover, by using a soluble silicate with a mole ratio of about 3.1 to about 3.3 moles of SiO₂ per mole of Na₂O, it is possible to produce a composition having a pH value of about 10.5 to about 11.5.

Commercially, sodium silicate solutions having mole ratios of about 2.6 to about 3.9 may be produced by heating SiO₂ and Na₂CO₃ to about 1400° F., solidifying and then forcing the solids into an aqueous solution while applying great amounts of both heat and pressure. Silicates having these higher mole ratios are more difficult to make soluble in water than those having a lesser ratio of SiO₂ per mole of Na₂O. These higher ratio materials offer benefits in the remedial composition of the present invention of lower pH values and essentially eliminate the possibility of crystalline silica content in the resulting product. By contrast, the lower ratio materials may contain a measurable percentage of crystalline solids. The amorphous nature of the silicates used in the remedial composition of the present invention are safer for both humans and animals alike. These materials a much more environmentally friendly in both terrestrial and aquatic settings.

Soluble silicates that are selected for higher mole ratio (silicate:alkali metal oxide) values are not just safer to handle and better for the environment, but also seem to provide greater long term cleaning power. In treating heavy metals, the soluble silicates are believed bind to the metal ions to render them relatively non-bioavailable and non-extractable from soil and so forth even with acidic solutions like those commonly used in toxicity characteristic leaching procedures, namely TCLP and SPLP testing.

It should also be noted that raw materials to produce soluble silicates may be derived from various sources. The base materials for producing the soluble silica may be mined from the ground, produced via chemical reactions or rendered from plant matter. A few suitable sources of biogenic silica include rice, sugar cane and corn. It is known that the ash produced by burning rice hulls may produce a significant amount of soluble silica with very low levels of impurities. This is shown and described in U.S. Pat. Nos. 5,833,940 and 6,524,543, both issued to Rieber et al. In regard to manufacturing the remedial composition of the present invention, any soluble silica possessing the desired mole ratios and pH values may be utilized without regard to the source of the raw materials. However, it is possible that for certain applications biogenic silica may be particularly desirable either because of its relatively high chemical purity or the availability of rice hulls in many countries like India and China.

The second component of the remedial composition is a surfactant. One basic definition of a surfactant is an organic molecule having both a hydrophilic (water seeking) and a hydrophobic (water repelling) portion. This dual chemical nature makes surfactants particularly useful in laundry detergent and similar applications. Surfactants are commonly used to assist cleaning because the hydrophilic portion seeks out water molecules and tends to stay in solution while the hydrophobic potion seeks out dirt or other solids. Much like laundry detergent, as the aqueous solution containing the surfactant is washed away, it will tend to carry the removed dirt with it. As used in the present invention, the surfactant works at the interface between solid and liquid phases to reduce the surface tension of the liquid and to thoroughly wet the medium to be treated including soil, sand, fly ash and other materials.

Surfactants are commonly categorized by the type of ionic charge that may be carried by the hydrophilic (water seeking) portion of the molecule. The three types are anionic for a negative charge, cationic for a positive charge, and nonionic for no charge. The preferred surfactants for use in the composition in accordance with the present invention are nonionic. These nonionic surfactants tend to derive their hydrophilic portions from polyhydroxy or polyethoxy structures in the molecule. One preferred nonionic surfactant is a glucoside-based surfactant marketed as Videt Q3 available from Vitech International of Milton, Wis.

The third component of the remedial composition is a polyol. The term polyol may be used to refer to a number of chemical compounds including a variety of glycols, glycerins and sugars. The preferred polyol for use in the remedial composition according to present invention would be propylene glycol, also commonly referred to as pet-safe antifreeze. It is further believed that tri-propylene glycol (TPG), glyceryl triacetate or methyl esters of fatty acids would be non-toxic and suitable for use in the present invention.

The forth component of the remedial composition is water. For most applications, this may be ordinary tap water, but it may also be desirable to use salt water as it may be more readily available near the job site and it should result in little or no loss of efficacy. It may also be desirable to use water containing a small percentage of dissolved oxygen gas (O₂). It is believed that even relatively small quantities of dissolved oxygen (less than 5 wt %) will serve to make the remedial composition faster acting.

The water is often the final component weighed out for blending the pollution remedial composition and usually comprises the remainder of the concentrate, that is to say whatever wt % is left over after subtracting the wt % total of each of the other components from 100 wt %. It is to be understood the water will complete the remedial composition whether there are just three other components (soluble silicate, surfactant and polyol) or additional components, like salt, are present.

Of course, this is merely the amount of water added to produce the pollution remedial composition in its most concentrated form. A considerable amount of water may be added later as a dilutant to create a wide array of cleaning and degreasing products for use in both commercial and home applications. The remedial composition as a blended concentrate may be further diluted in ratios ranging from about 1 part water to 1 part remedial composition up to and including about 30 parts water to 1 part remedial composition.

The remedial composition of the present invention is also notable for having very low and usually not detectable volatile organic compound (VOC) content. In many embodiments, the remedial composition will exhibit no measurable VOCs. This is particularly notable because many VOCs have been categorized as carcinogens, asthmagens, neurotoxins, endocrine disruptors and so forth. Very low and zero VOC products are highly desirable in the new green economy. A remedial composition comprising a soluble silicate, a surfactant, a polyol and water in accordance with the present invention qualifies as “zero VOC” according to current guidelines. If the vapor pressure of a liquid at room temperature is less than 0.1 mm Hg, then that composition qualifies as “zero VOC”.

A number of exemplary treatments of various forms of hazardous waste materials in a number of different environments may be considered. Unless noted otherwise, the exemplary treatments may be carried out using a remedial composition of about 59 wt % of sodium silicate, about 0.5 wt % of nonionic surfactant, about 1.0 wt % propylene glycol, and about 39.5 wt % water. This remedial composition is then further diluted with about 10 parts water to 1 part remedial composition prior to treatment. The 10:1 diluted remedial composition is then applied at about 2.5 to about 4.8 gallons per ton of contaminated soil.

One treatment for soil, sand and fly ash contaminated with metal ions may be outlined in several distinct processing steps. The soil, sand or fly ash must be collected and tested to determine baseline values of metal ions to be treated. This testing will usually be a leachate test using an acidified extraction solution, such as TCLP or SPLP. The soil, sand or fly ash should then be sifted or screened into different sizes to increase particle uniformity. Larger particles may be reduced in size using a hammer mill, ball mill or the like suitable for crushing rocks and mineral materials. Once particle uniformity is assured, the contaminated materials may be transferred by conveyor to the treatment stage.

Prior to treatment with the remedial composition it may be particularly advantageous to make measurements of the contaminated materials moisture content and pH value. This is because it would require less of the remedial composition if the soil, sand or fly ash was brought up to a reasonably moist condition of at least about 10 to about 15 wt % water content to help ensure good contact between the remedial composition and the contaminated media. Also, if the contaminated media is particularly acidic it may be possible to pre-treat the media in such a way to neutralize the acids prior to treatment.

It may also be desirable to adjust the pH value of the remedial composition between about 10.0 and 12.0, and preferably between about 10.5 and 11.5, to within a tolerance of about 0.1 for a particular metal ion to be treated most effectively. The pH value of the remedial composition varies slightly from one batch to another but it may be further dialed in by using trace amounts of a known acid or base. It is believed that even small pH variances of about 0.1 may have a noticeable effect on both the speed and efficacy with which the remedial composition will bind to a particular metal ion contaminant.

The soil, sand or fly ash may now be treated with the remedial composition outlined herein. This step may be carried out by spraying the contaminated media as it passed on the conveyor or preferably by placing it into a static mixer and thoroughly combining the dry media with the wet remedial composition for a period of time sufficient to ensure good contact. It is believed that a period of 10 minutes mixing should be sufficient for each batch, but this mixing time may be adjusted up of down by the operator depending upon the moisture content of the contaminated media and other factors.

The treated materials should now be transferred to plastic sheeting or the like and allowed to rest for several days. This rest period may take from about 1 to 10 days to allow the remedial composition to bind to the metal ions and form stable metal-silicate molecules. Once this chemical transformation takes place the metal ions will no longer be free to leach out or become readily extracted from the soil, sand or fly ash. Consequently, the treated metal ions will have greatly reduced mobility and bio-availability. The rest period may vary based on the level of contamination and on the particular metal ions being treated. It is advisable to perform leachate testing (TCLP or SPLP) upon the treated pile to ensure that the toxicity has been reduced to the desired safe levels before landfilling or re-depositing the contaminated materials.

On site field testing of the treated piles will permit adjustment of the concentration of the remedial composition, the ratio of the composition to the contaminated media, and the resting period. It is also possible that the contaminated media may require a second remedial treatment including mixing and resting to achieve the desired target levels of toxins which are permitted in a particular city or state.

Once the desired target levels of toxicity have been attained it is now possible to move the treated piles either into a landfill or back into the original location from which it was removed. It is important to note that moving the contaminated media to a landfill is a commonly accepted environmental treatment, but that the landfill selected will vary dramatically in price depending entirely on the TCLP or SPLP test results for the contaminated media. If it is possible to lower the hazardous waste class rating by even one increment, treatment with the remedial composition of the present invention could be both environmentally and economically beneficial. Additionally, if it is environmentally permissible to simply place the treated media back into the excavated area, it creates a virtual in situ treatment in that the soil, sand or fly ash will not need to be subsequently loaded and transported to a remote landfill at all.

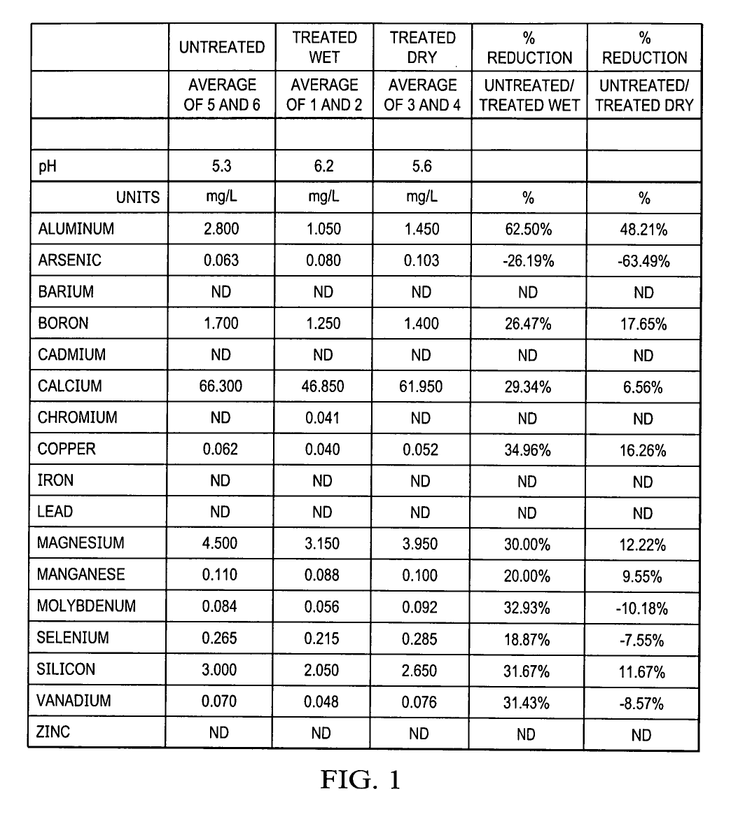

Laboratory testing under controlled conditions has shown a number of very promising results so far. In the following examples, shown and described in FIGS. 1-3, pure lab grade sand was dosed with a specified concentration of various metal ions. Referring now to FIG. 1, the dosed sand samples were divided into 6 equal portions in separate containers. Trays 1 and 2 were treated with the remedial composition, allowed to rest briefly and subjected to TCLP testing while still damp. Trays 3 and 4 were treated with the remedial composition, allowed to rest for about 2 days and subject to TCLP testing after drying out. Trays 5 and 6 were untreated control samples and were subjected to TCLP testing. As shown in FIG. 1, the treated sample trays 1-4 showed reductions in the concentration of metal ions in the extracted TCLP leachate. Many of the metal ion concentrations were reduced by about 25% to 35% when compared to the control sample trays, and aluminum was reduced by over 62% with a single treatment of the remedial composition.

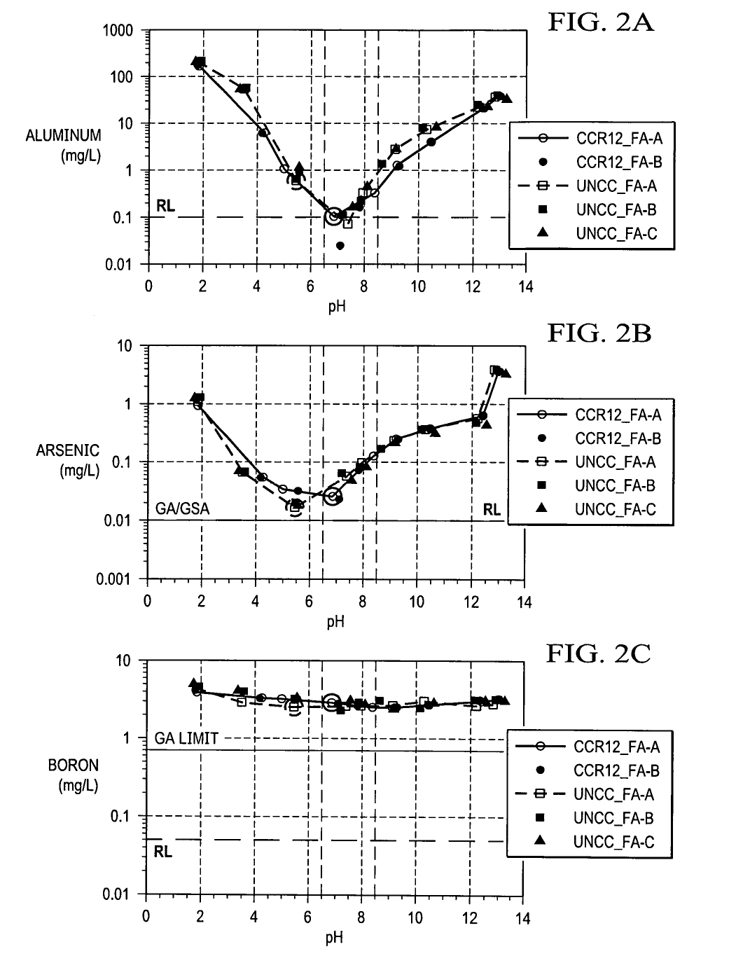

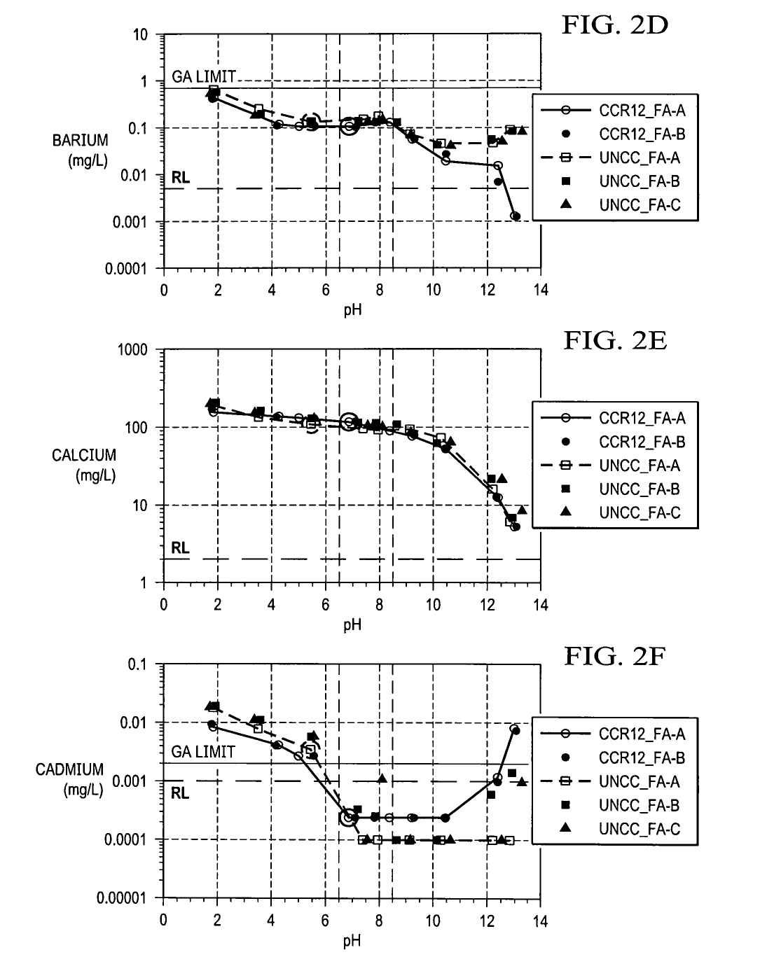

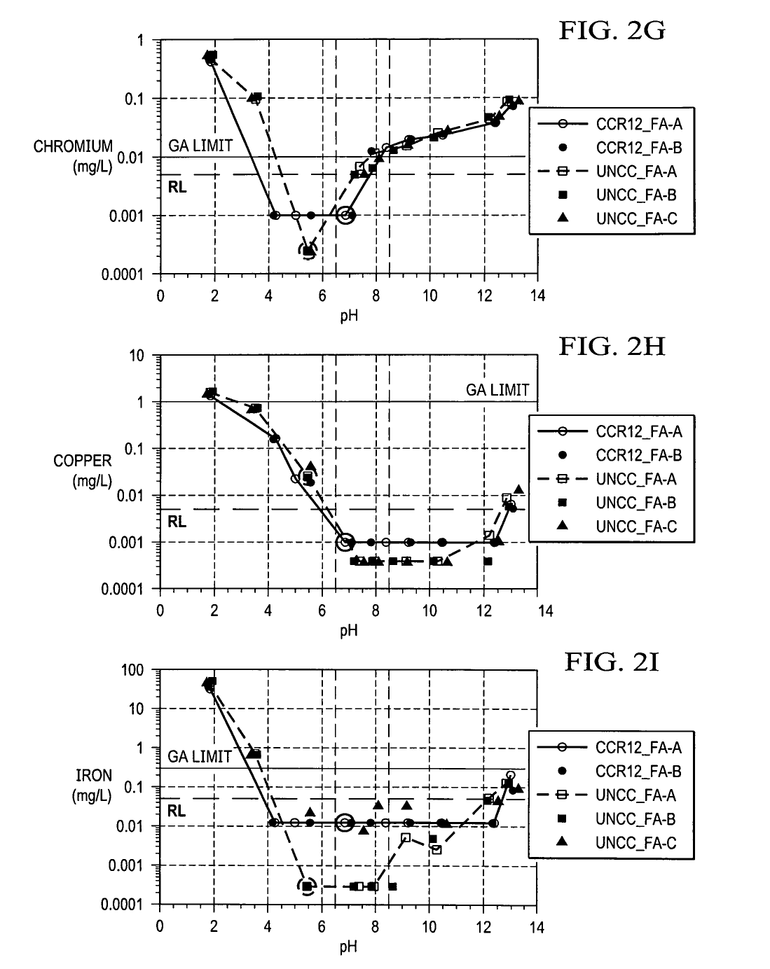

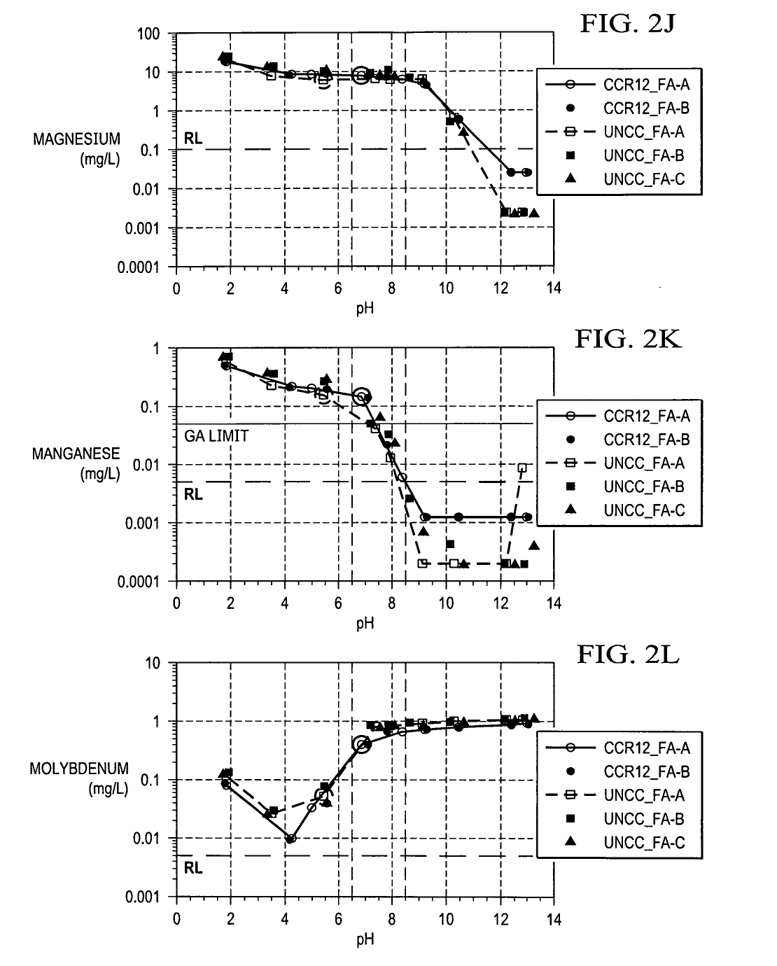

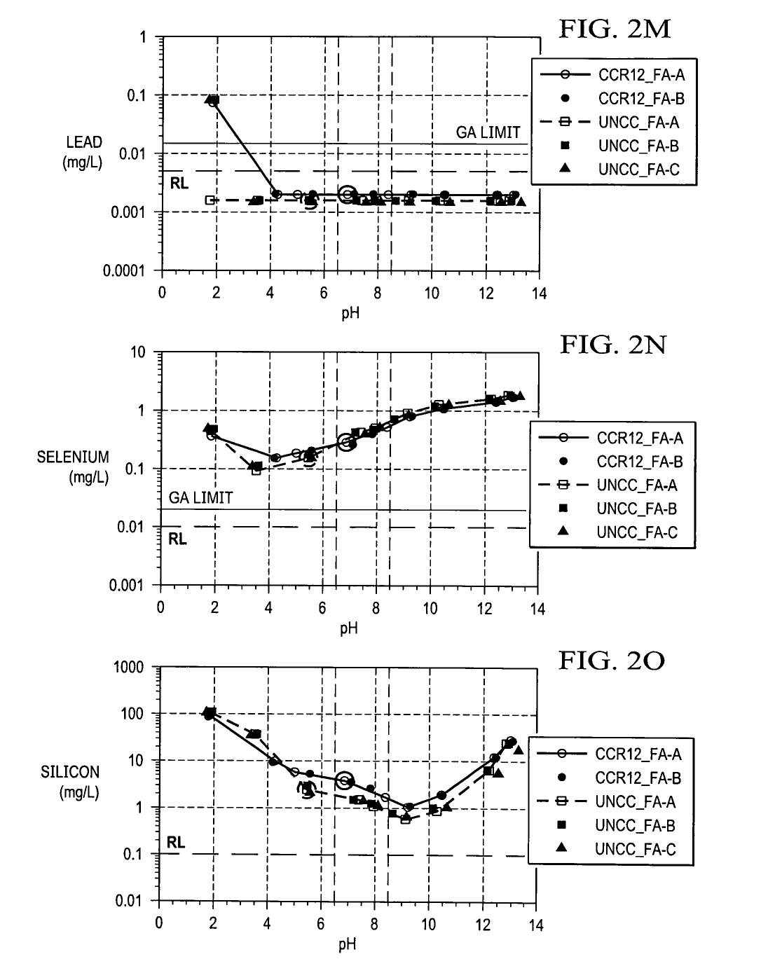

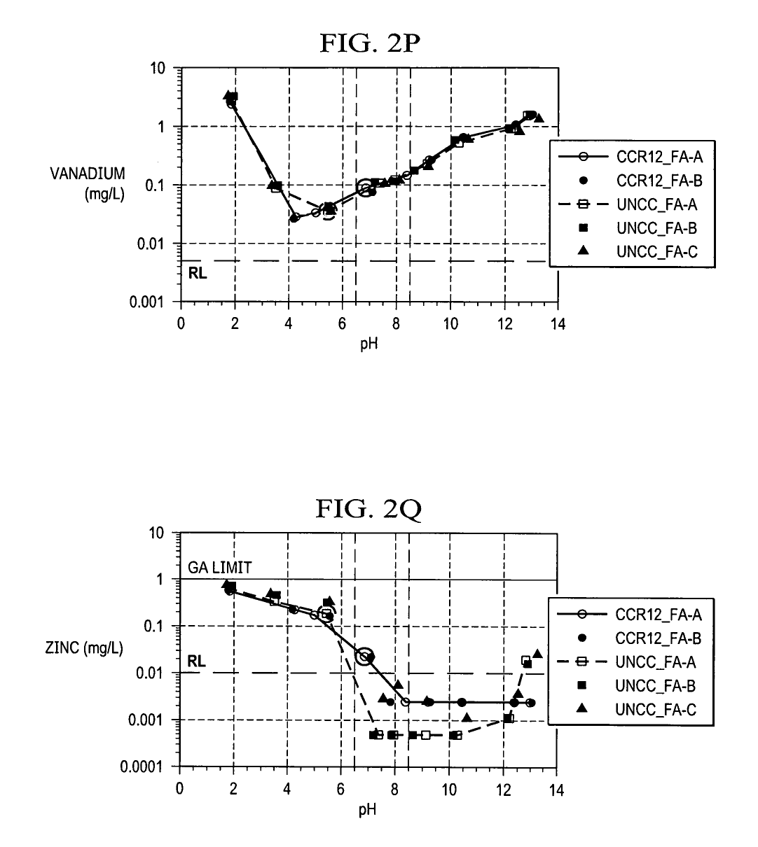

Referring now to FIGS. 2A-2Q, it is believed that particular metal ions will react more quickly or be treaded more efficiently if the pH value of the surrounding soil, sand or other media is adjusted to be within a particular target pH range. An adjusted pH value may be achieved by pre-treating the contaminated media with small amounts of a known acid or base prior to treatment with the remedial composition. As shown in FIGS. 2A-2Q, lab samples containing known concentrations of various metal ions were pre-treated to adjust the pH value to range from about 2 to about 13. The pre-treated samples were then treated with the remedial composition and subjected to TCLP testing to evaluate efficacy within various target pH ranges. Although some metal ions, see FIG. 2C (boron), did not seem to respond well to treatment with the remedial composition in any pH range, other metal ions showed dramatic improvement when treated following adjustment to a particular target pH range. Several metal ions including aluminum (FIG. 2A), arsenic (FIG. 2B) and chromium (FIG. 2G) show rather narrow target pH ranges that appear to be optimal for treatment with the remedial composition. Other metal ions like cadmium (FIG. 2E), copper (FIG. 2H) and zinc (FIG. 2Q) show preferred target pH ranges, but these may be somewhat broader or less clearly defined at this time.

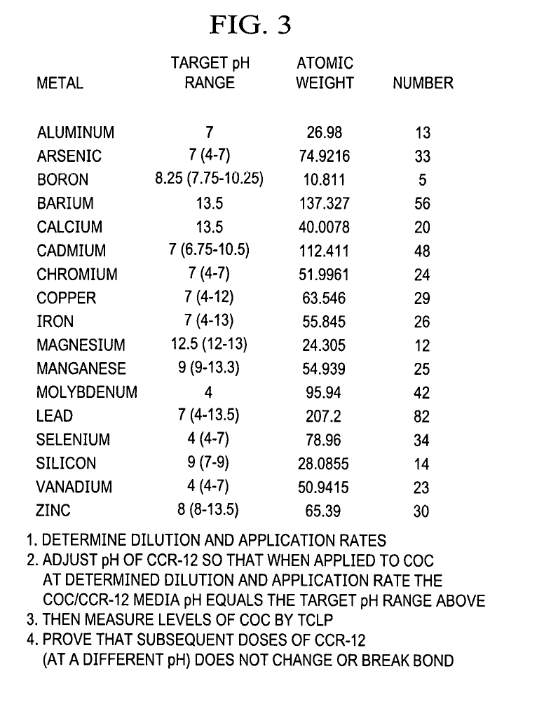

With reference to FIG. 3, the preferred target pH ranges are summarized for the various metal ions in alphabetical order. These target pH ranges may be the subject of further lab testing, but are presented to illustrate the improvement in the efficacy of the remedial composition by adding a pre-treatment step to the overall method. As shown in FIG. 3, the preferred target pH range may be quite narrow or somewhat broad depending upon the metal ion to be treated in the contaminated soil, sand or other media. Field testing is recommended to determine the most significant contaminants in a given treatment zone and the target pH range may then be determined to treat these contaminants most efficiently with the remedial composition.

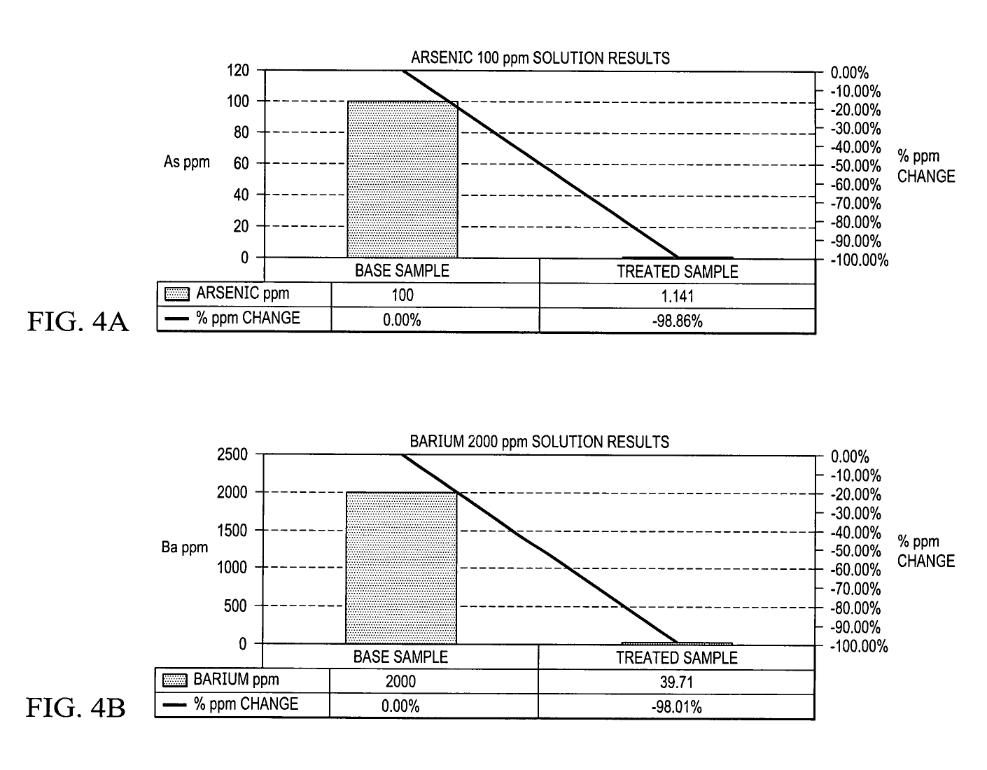

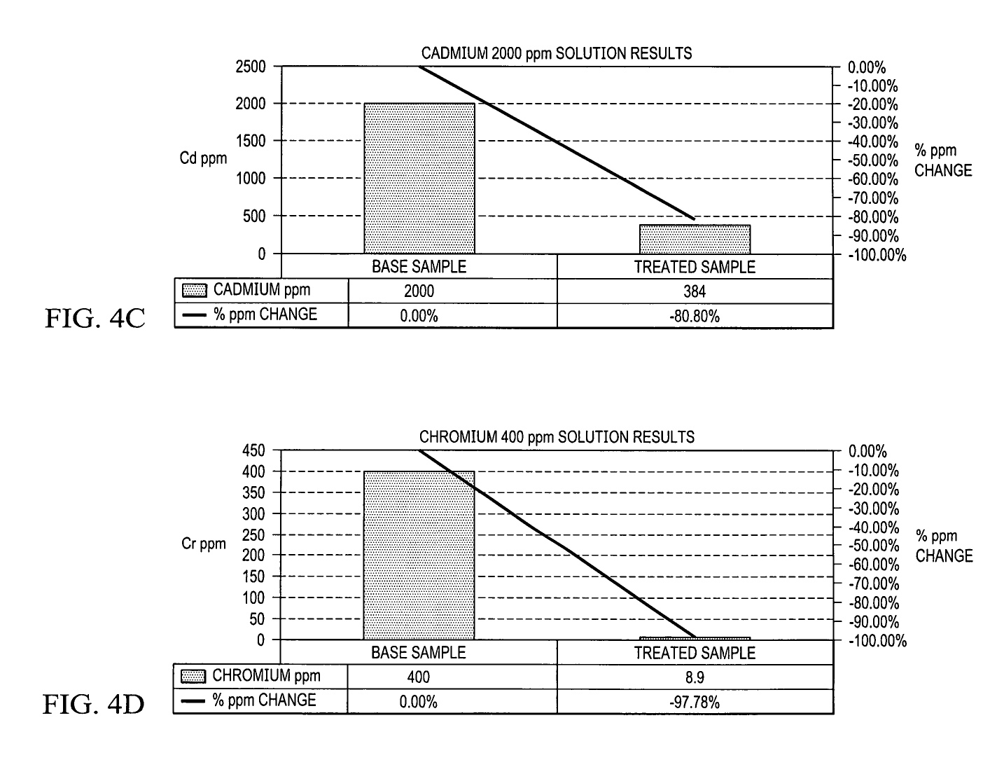

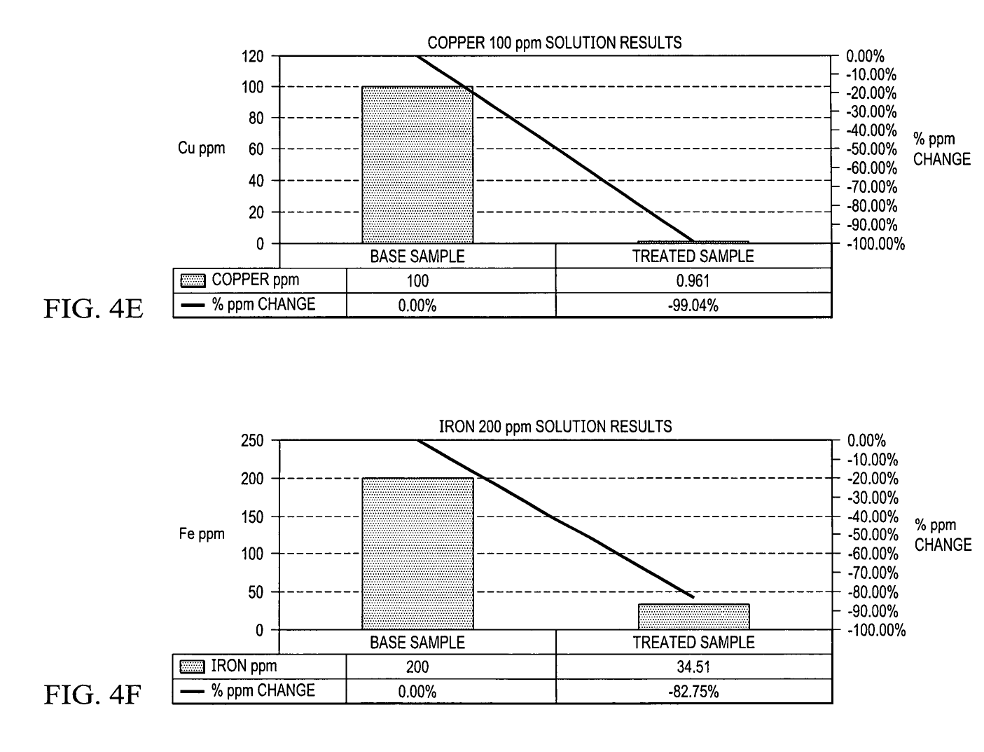

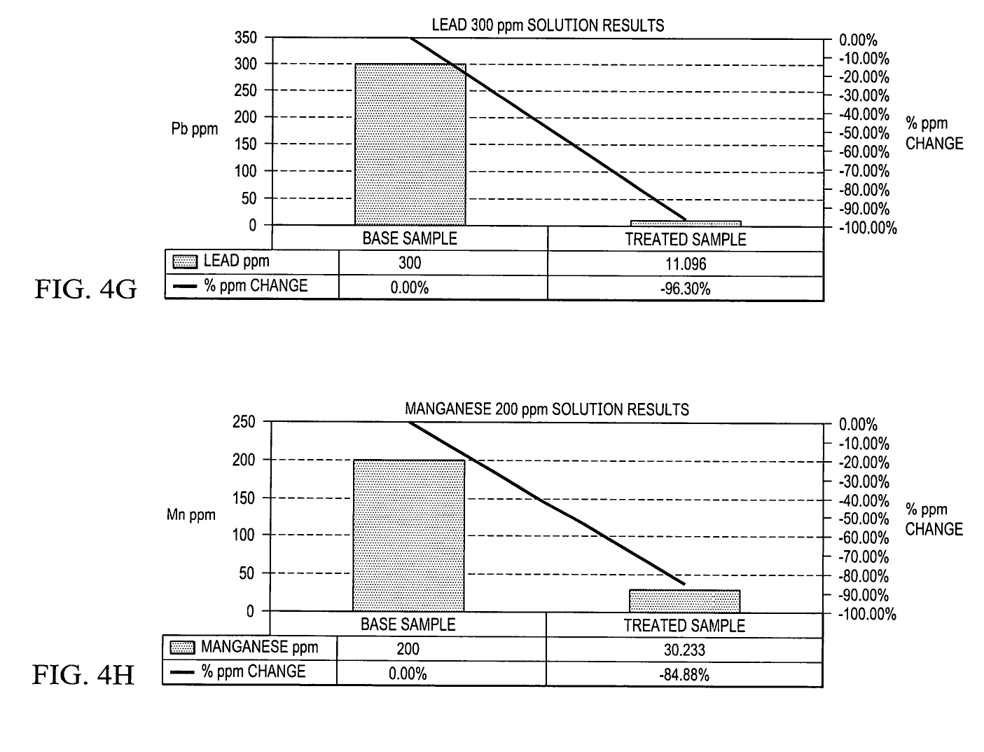

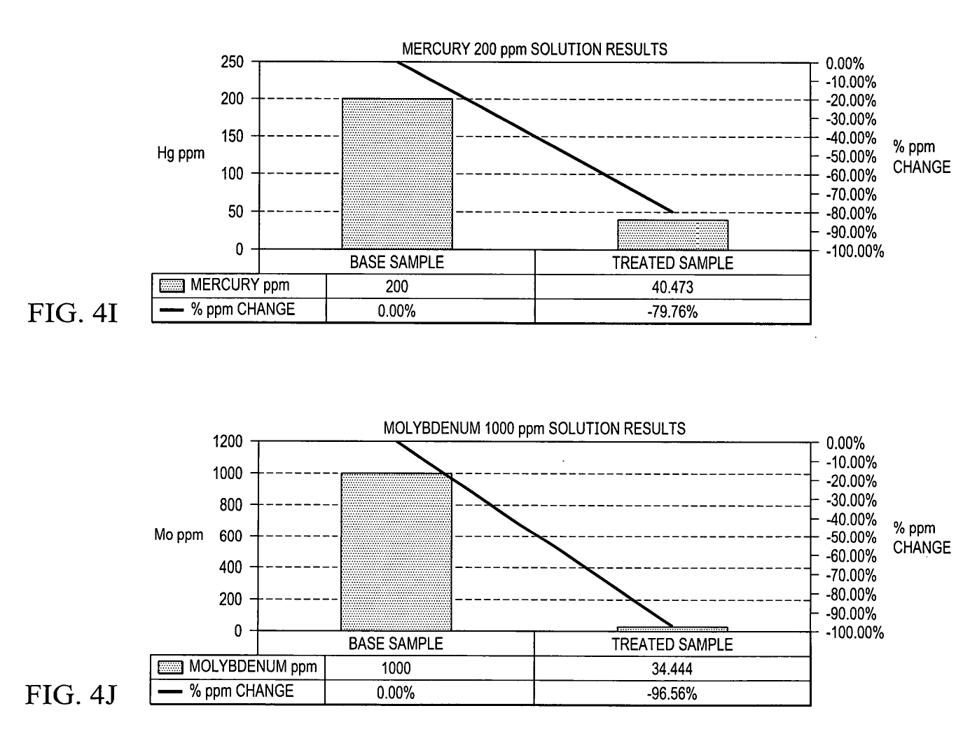

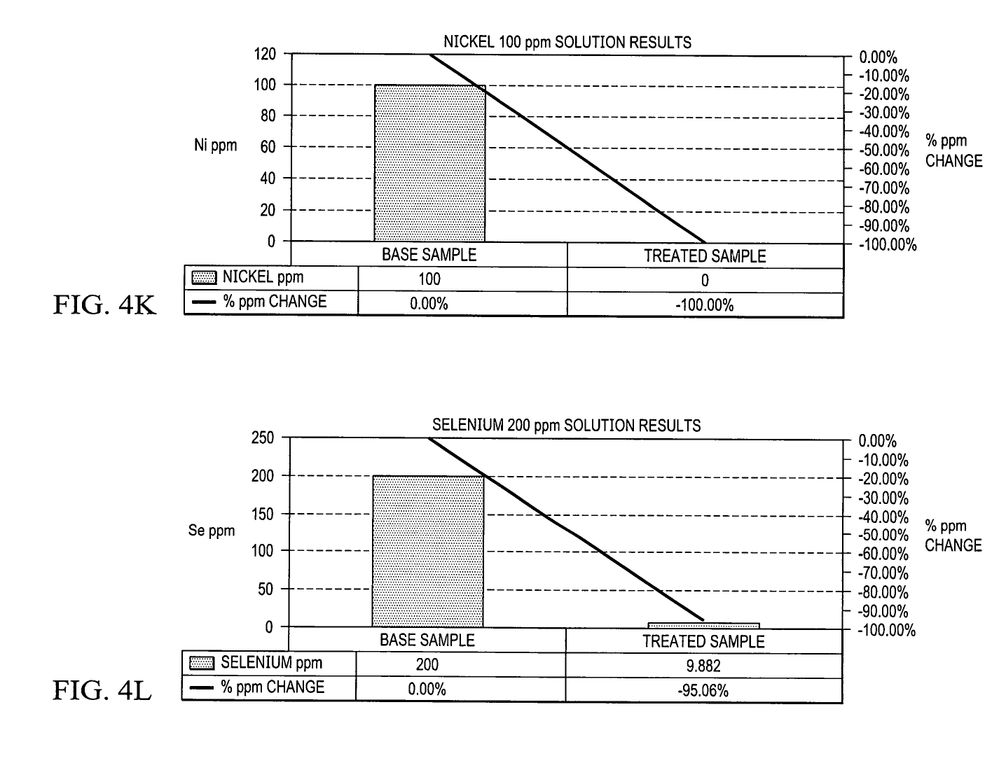

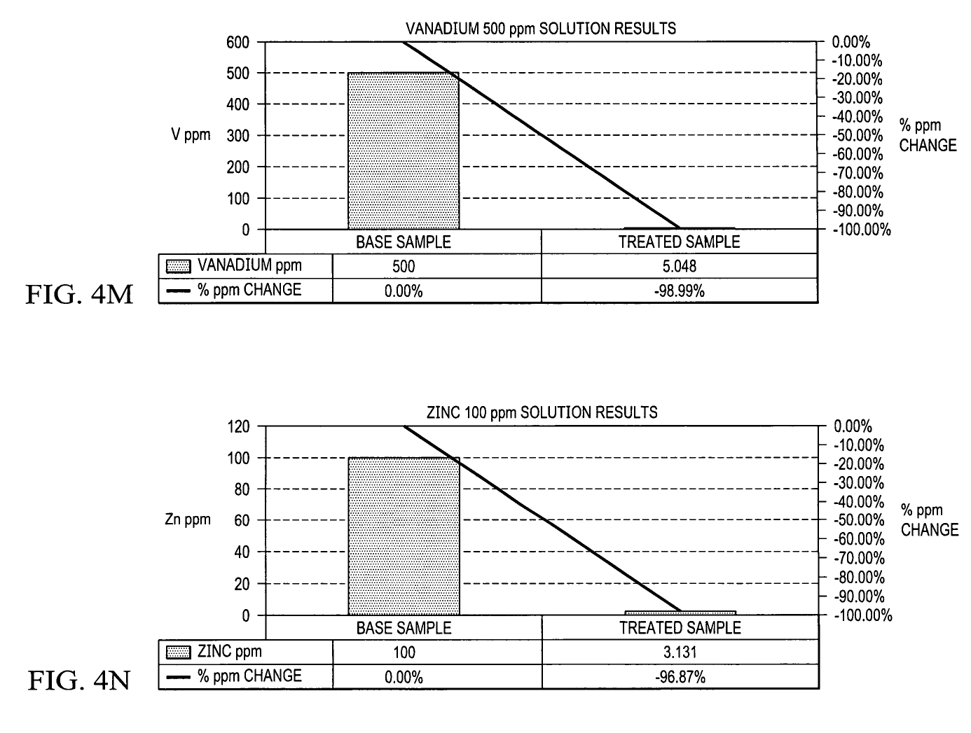

Further lab testing has shown great promise in regard to the treatment of water and other aqueous media. In the following examples, shown and described in Table 1 and in FIGS. 4A-4N, deionized water (DI water) was dosed with a specified concentration of various metal ions. The samples were then split into an untreated control sample and a treated test sample with exactly 5 wt % of the remedial composition. The samples were not pH buffered or adjusted in any way. Accordingly, the treated samples were somewhat alkaline (basic) in nature due to the natural pH of the remedial solution of about 11.

TABLE 1

| | | Untreated | | Treated w/ | |
|---|---|---|---|---|---|
| | | Base | | Remedial | |
| Metal | pH before | Solution | pH after | Comp | % ppm |
| Contaminant | Treatment | ppm | Treatment | ppm | Change |
| As | 6.9 | 100 | 11.9 | 1.141 | 98.86% |
| Ba | 6.87 | 2000 | 11.67 | 39.71 | 98.01% |
| Cd | 6.97 | 2000 | 11.79 | 384 | 80.80% |
| Cr | 6.92 | 400 | 11.58 | 8.9 | 97.78% |
| Cu | 6.89 | 100 | 11.58 | 0.961 | 99.04% |
| Fe | 6.88 | 200 | 11.55 | 34.51 | 82.75% |
| Hg | 6.9 | 200 | 11.76 | 40.473 | 79.76% |
| Mn | 6.91 | 200 | 11.54 | 30.233 | 84.88% |
| Mo | 0.72 | 1000 | 11.65 | 34.444 | 96.56% |
| Ni | 6.01 | 100 | 11.73 | 0 | 100.00% |
| Pb | 0.83 | 300 | 11.57 | 11.096 | 96.30% |
| Se | 6.91 | 200 | 11.58 | 9.882 | 95.06% |
| V | 6.96 | 500 | 11.56 | 5.048 | 98.99% |
| Zn | 6.89 | 100 | 11.65 | 3.131 | 96.87% |

The control and test samples were then subjected to a novel, non-destructive testing procedure referred to as Proton Induced X-ray Emission or PIXE. In the PIXE testing protocol, a high-energy beam of protons is aimed at a target sample and results in the excitement of inner shell electrons in the target atoms. The expulsion of the inner shell electrons gives off X-ray emissions having distinctive energy profiles which are unique to the elements producing them. The resulting energy profiles of the target media may then be compared to known profiles for each chemical element. In this way, it is possible to quantify the amount of metal ion contaminant which has been remediated by treatment with the remedial solution without vaporizing or destroying the test sample. This is very different than gas chromatography which requires vaporizing a sample of leachate following treatment in a typical TCLP test.

Moreover, it is thought that the PIXE test is a superior test for demonstrating the efficacy of the remedial solution of the present invention. This is because it is believed that the remedial solution binds to the metal ions and renders them non-bioavailable, but that by vaporizing the leachate for a standard TCLP, at least a portion of the bound up ions are freed and subsequently detected. In nature, the treated water, sand, soil or other media would never be subjected to such a destructive force, with the possible exception of a direct strike from a bolt of lightning.

Referring now to Table 1 and FIGS. 4A-4N, the results of PIXE testing on 14 known metal ions having varying levels of toxicity in water are shown and described. Table 1 summarizes the results for deionized water samples spiked with arsenic (As), barium (Ba), cadmium (Cd), chromium (Cr), copper (Cu), iron (Fe), mercury (Hg), manganese (Mn), molybdenum (Mo), nickel (Ni), lead (Pb), selenium (Se), vanadium (V) and zinc (Zn). As indicated in Table 1, the reduction of available free metal ions in the treated aqueous solutions was quite dramatic. Each of the treated samples showed a reduction of at least 80% and most of the samples showed a reduction of greater than 95%. These results are particularly exciting in view of the dangers presented by even very small amounts of arsenic (As), chromium (Cr) and lead (Pb) in rivers, lakes or drinking water. With just a single 5 wt % treatment of the remedial composition, 10 of the 14 metal ions tested were reduced by 95% or more.

It is now possible to consider a number of treatment methods for reducing free metal ions in aqueous (water-based) solutions. One such method may involve the drawing off of contaminated water from coal ash ponds or other settlement storage areas and mixing with the remedial composition of the present invention in large tanks. These tanks may be stirred or aerated to produce agitation and to ensure proper mixing. It is believed that the limiting factor in the treatment of metal ions is simply making good contact with the contaminants.

Another possible treatment method involving aqueous media would be to simply to pump the remedial solution into a settlement pond having a known volume to achieve the desired dosage. Mixing may again be achieved by aeration or the like. However, this form of in situ or in place treatment method may be complicated by the presence of solid contaminants below the water to be treated. Accordingly, it may be possible to treat the solids by injecting the remedial composition under pressure below the water and into the accumulated solids. The remedial composition may then percolate or bubble slowly upward through the accumulated solids and into the water to be treated.

While a number of preferred embodiments of the invention have been shown and described herein, modifications may be made by one skilled in the art without departing from the spirit and the teachings of the invention. The embodiments described herein are exemplary only, and are not intended to be limiting. Many variations, combinations, and modifications of the invention disclosed herein are possible and are within the scope of the invention. Accordingly, the scope of protection is not limited by the description set out above, but is defined by the claims which follow, that scope including all equivalents of the subject matter of the claims.

What I claim as my invention is:

1. A remedial composition comprising:
from about 50 to about 70 wt % of a soluble silicate;
from about 0.5 to about 1.0 wt % of a surfactant;
from about 0.5 to about 1.0 wt % of a polyol;
from about 28 to about 49 wt % water; and
wherein said soluble silicate has a mole ratio of about 2.6 to about 3.8 moles of silicate per mole of alkali metal oxide.

2. The remedial composition according to claim 1, wherein said soluble silicate is sodium silicate.

3. The remedial composition according to claim 1 wherein said soluble silicate is potassium silicate.

4. The remedial composition according to claim 1, wherein said surfactant is a nonionic surfactant.

5. The remedial composition according to claim 1, wherein said polyol is propylene glycol.

6. The remedial composition according to claim 1, wherein said composition has a liquid vapor pressure of less than 0.1 mm Hg at room temperature.

7. The remedial composition according to claim 1, wherein said composition is further diluted with water at ratios ranging from about 1:1 to about 30:1 to produce a variety of useful solutions.

8. A method of treating a contaminated medium like soil, sand or fly ash, said method comprising the steps of:
producing a remedial composition according to claim 1;
filling a container with said remedial composition;
immersing said contaminated medium in said remedial composition;
agitating said contaminated medium in said remedial composition; and
filtering said remedial composition to separate said contaminated medium.

9. The method treating a contaminated medium according to claim 8, further comprising the step of measuring the pH value of the contaminated medium before immersing in the remedial composition.

10. The method treating a contaminated medium according to claim 9, further comprising the step of adjusting the pH value of the contaminated medium before immersing in the remedial composition.

11. The method treating a contaminated medium according to claim 8, further comprising the step of measuring the moisture content of the contaminated medium before immersing in the remedial composition.

12. The method treating a contaminated medium according to claim 9, further comprising the step of adjusting the moisture content of the contaminated medium before immersing in the remedial composition.

13. A method of treating a contaminated medium like soil, sand or fly ash, said method comprising the steps of:
producing a remedial composition according to claim 1;
screening said contaminated medium to achieve a uniform particle size;
spraying said contaminated medium with said remedial composition; and
agitating said contaminated medium to combine with said remedial composition.

14. The method of treating a contaminated medium according to claim 13, further comprising the step of milling the contaminated medium prior to screening.

15. The method of treating a contaminated medium according to claim 13, further comprising the step of adjusting the pH value of the contaminated medium before spraying with the remedial composition.
